(19) United States
(12) Patent Application Publication
(10) Pub. No.: US 2006/0112218 A1
(43) Pub. Date: May 25, 2006

(54) Systems and methods for an improved computer long-term memory comparing device

(76) Inventors: Steven Bress, Germantown, MD (US); Mark Joseph Menz, Folsom, CA (US); Daniel Bress, Germantown, MD (US)

Correspondence Address: Steven Bress, 7851-C Beechcraft Avenue, Gaithersburg, MD, 20879, US

(21) Appl. No.: 10/995,631

(22) Filed: Nov. 23, 2004

(51) Int. Cl. G06F 12/00

(52) U.S. Cl. 711/112

(57) ABSTRACT

An improved comparing device for comparing computer long-term memory devices such as hard drives and compact flash memory, to determine if they are exact copies. Our current invention is a stand-alone device. A user connects long-term memory devices he desires to compare to our device. Our device contains logic and circuitry that perform operations on these devices to determine if they are exact copies, including “hidden” areas, while protecting the devices from any changes. Our device has a very simple user interface. This simplified user interface makes it difficult and unlikely to use our device incorrectly.

### BACKGROUND OF THE INVENTION

A. Field of Invention

This invention relates to computers, in particular, computer long-term memory devices such as hard drives and compact flash memory. In particular it relates to comparing data on these devices.

B. Description of Related Art

There are many situations where it is desirable to compare two computer long-term computer memory devices. The fields of law enforcement, information security, cyber-crime and the Judicial System, among others, have special requirements for comparing memory devices.

When a law enforcement official confiscates a computer long-term memory device, such as a hard drive, the drive enters a chain of custody. Any inadvertent changes to data on the drive may change important evidence. In order to avoid this, a copy of the drive is typically made, and this copy is used by the forensics labs instead of the original. For this process to work correctly, it is not enough for the copy to have all of the data files of the original, the data must be arranged on the copy in the exact same pattern as the original. In addition, portions of the drive that may be interpreted as blank (“hidden”) space by an operating system, such as Windows, must also be copied. A technically savvy bad guy may hide the evidence that is being sought in this blank area. A copy that didn't take this into account would have limited utility for the forensics lab. Once a copy is made, the copy must be compared to the original (including “hidden areas”) before it can be accepted for forensic, security or legal purposes. In addition, the drives being compared must be protected from any changes.

Currently, comparing drives may be made using specialized software on a PC, but if the PC uses an operating system such as Windows, simply starting the computer with a drive attached is enough to make changes to the drive. Additionally, using a PC ties up an expensive machine.

Currently there are copier devices, which in addition to copying have a compare function. A company named Logicube produces such a device that is intended for law enforcement work. It has numerous operating modes and options that must be specified before used. Options are selected through the use of a number of buttons and a small display. One of the options is to delete the contents-of-what will be-the destination drive. This device offers little protection to- the drives. Additionally, it does not easily compare “hidden” areas, and restore the drives to their original configuration.

Law enforcement and judicial professions must be prepared to defend any and all actions to an evidence drive, in court. State of the art devices require complicated user input to perform a compare, with the possibility of errors being made and data being changed.

Accordingly, there is a need in the art for an improved computer long- term memory comparing device.

### SUMMARY OF THE INVENTION

Please refer to FIG. 6. Our invention 1000 is a physical device that connects to two (or more) long-term storage devices such as hard drives 620 and 640. The long-term storage devices are connected to our device through cables 610 and 630. One of the long-term storage devices is designated as an Original device 620 and the other is designated as a Copy device 640. Our device compares the data on long-term storage device 620 with data on long- term storage device (Copy) 640.

Our current invention may be produced in a small size, allowing its use in field work.

Our current invention is operating system and platform system independent.

Our current invention simplifies the compare process. In order to eliminate as many user errors as possible, the number of user controls is kept to a minimum. In the preferred embodiment, the only user control is a ‘Start’ switch. A few LED indicators may show status and errors, while a Light Emitting Diode (LED) bar graph may show percentage compare complete.

Our current invention is able to both read “hidden” areas of drives and restore the drives controllers to their original states. This is accomplished by using systems and methods such as the ones detailed in our U.S. Provisional Patent Application 60/443,388.

Our current invention is able to protect the drives being compared from any changes. This is accomplished through protective circuitry and by restricting the commands our device may issue to a drive, to commands that do not make any permanent change to the drive.

### BRIEF DESCRIPTION OF THE DRAWINGS

The present invention is illustrated by way of example and not limitation in the figures of the accompanying drawings, in which like references indicate similar elements and in which:

FIG. 1 is an illustration of a functional overview of our invention;

FIG. 2 is a sample printout from our invention;

FIG. 3 is an illustration of the logic flow of our invention;

FIG. 4 is an illustration showing major electronic components and their connections, for the preferred embodiment;

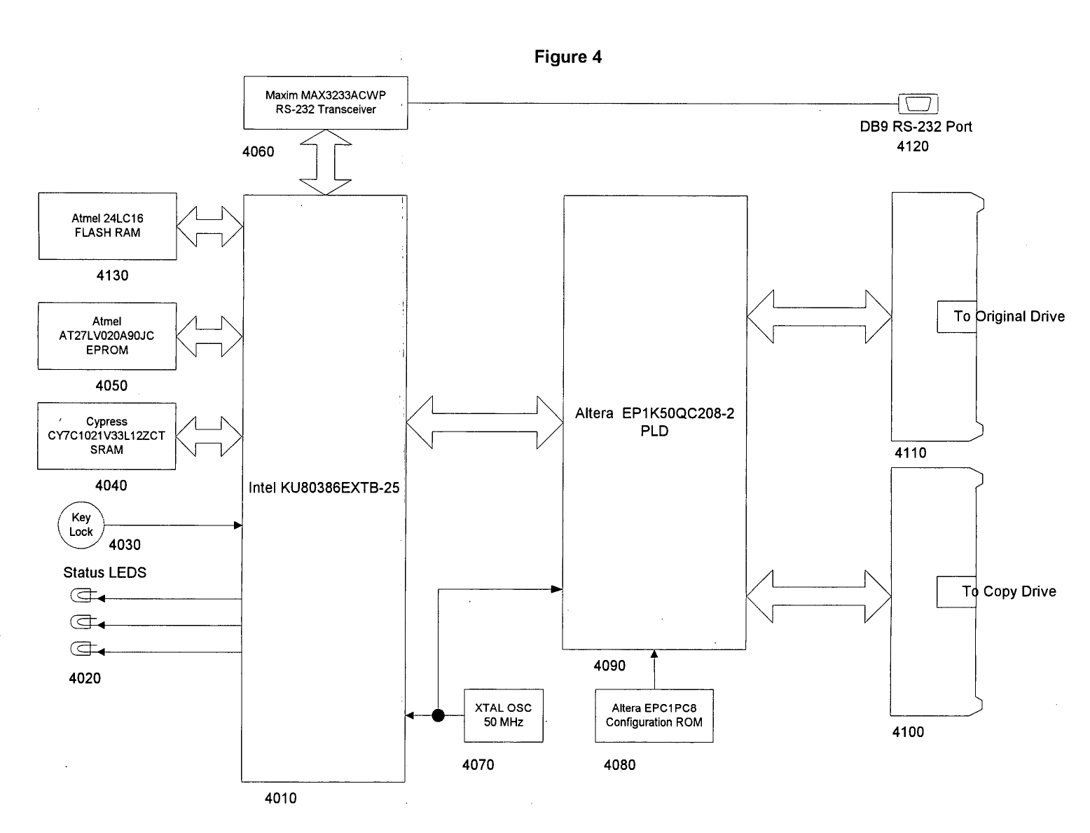

FIG. 5 is an illustration of the functions of a programmable logic device (PLD);

FIG. 6 is a block diagram of our invention.

### MODERN LONG-TERM MEMORY DEVICE INTERFACES

Two of the modern drive interface specifications are Integrated Drive Electronics (IDE), also known as AT Attachment (ATA), and Small Computer System Interface (SCSI). For the sake of clarity our description is based on an IDE drive, but our invention is not limited to IDE drives. One skilled in the art would appreciate that modern long-term memory device interfaces share the same functionality and that a detailed description of our device as relates to one interface would provide enough detailed information to produce a similar device for another modern interface.

An IDE drive has two major components; interface electronics and some form of long-term storage media. For long-term storage, a spinning magnetic disk (hard drive) is most commonly used, but is by no means the only way to store data. Recently, compact flash memories have been brought to market that act as hard drives and have an IDE interface, but they use Flash random access memory (RAM) as the storage media. Flash RAM is a special type of RAM that retains its data after power has been removed from the system. Other types of media that have been used for long-term data storage on an IDE device include magnetic tape and optical media such as compact disc (CD) and digital versatile disc (DVD) devices.

For the sake of clarity, we will assume that the IDE device in question is a hard disk drive. The computer shall be called the Host and the IDE drive shall be called the Drive.

All communications with the Drive is through its IDE interface. This is a well-defined interface that has addressable memory registers to which the Host can write commands. The Host may also read these registers. When read, these registers typically have status information. The IDE interface has memory that is used to buffer data going to or coming from the Storage Media.

In order to read data from an IDE drive, a command must be written to registers in the drive. These registers are used to request operations from the drive. The drive may be asked to provide information about itself, or it may be asked to return one or more sectors of data. This point cannot be stressed enough. In order to read data from an IDE drive, data must be written to it.

This makes the process of preventing data from being written to an IDE drive non-intuitive. In order to read an IDE Drive, the read request must be written to the IDE interface on the drive. Even though the registers need to be written, the act of writing registers by itself does not make changes to the drive's permanent storage.

### Detailed Description

In the following detailed description, numerous specific details are set forth in order to provide a thorough understanding of the present invention. However, it will be understood by those skilled in the art that the present invention may be practiced without these specific details. The use of specific electronic components is disclosed to provide a thorough understanding of the preferred embodiment. However, one skilled in the art will appreciate that there are many electronic components with similar functionality, and the present invention is not limited to the components disclosed. In other instances, well known methods, procedures, components, and circuits have not been described in detail so as not to obscure aspects of the present invention.

For the sake of clarity, this detailed description of the preferred embodiment will describe an Integrated Drive Electronics (IDE) hard drive. One skilled in the art would appreciate that the method and system described here can be applied to other interfaces and other long-term storage devices.

For the sake of clarity, the following discussion of the preferred embodiment will describe comparing between two drives. One skilled in the art would appreciate that the method and system described here can be applied to comparing multiple drives.

For the sake of clarity, the following discussion of the preferred embodiment will call one of the drives to be compared an “original” and the other a “copy”. One skilled in the art would appreciate that in the case of the two drives being exactly the same size, there is no functional difference between which is called “original” and which is called “copy”.

OVERVIEW

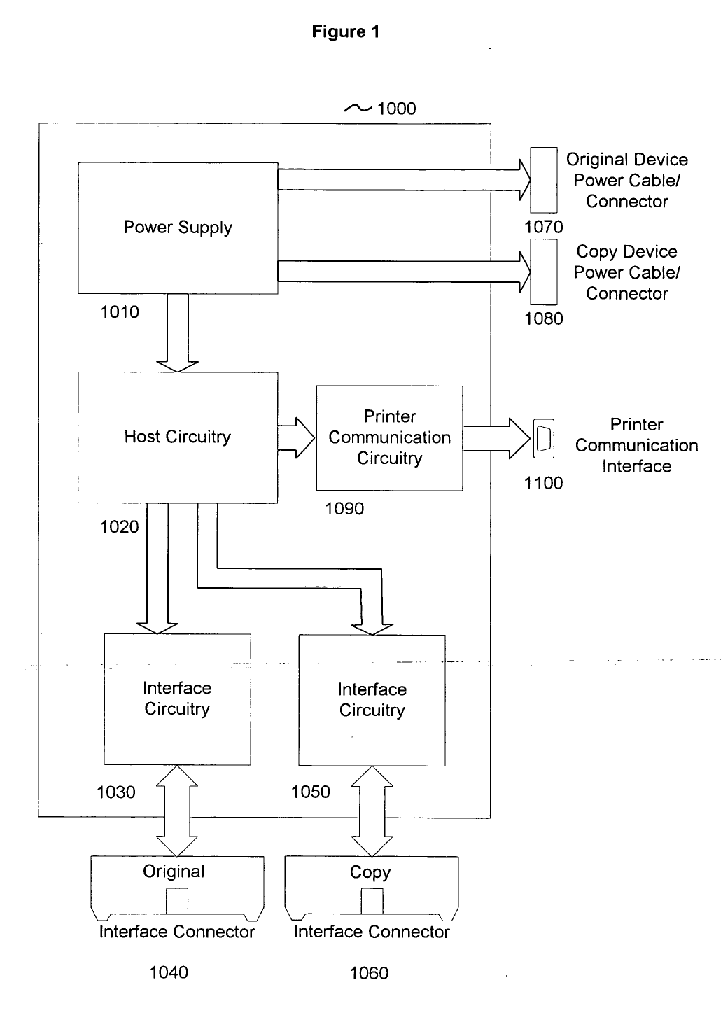

In a standard configuration, our device is connected to two standard IDE hard drives. Please refer to FIG. 1. A drive containing the Original data is connected through a standard cable to Interface Connector 1040. Power for this drive is provided through an industry standard drive power connecter 1070. A drive containing the copy of the Original data, or Copy Drive, is connected through a standard IDE cable to Interface Connector 1060. Power for this drive is provided through an industry standard drive power connecter 1080.

To a drive, our device appears to be a host computer. The Original and Copy drives are electrically isolated from each other through the use of separate Interface Circuitry for each drive, 1030 for the Original, and 1050 for the Copy. In a standard PC, two IDE drives can share the same interface circuitry. This has two disadvantages that are overcome by our invention.

The first is that with two drives using the same interface circuit, there is only half of the bandwidth available in the circuit for each drive. When comparing two drives on the same circuit, the speed of the compare will be no more than ½ of the maximum bandwidth of the interface circuit, as the data must be read from one drive, then read to the other.

The second problem is that if two IDE drives share the same interface circuit, they must be configured by the user correctly, typically by using small jumper blocks, so that one drive is a master and the other a slave. This is a procedure that is fairly simple to a trained operator, assuming that proper documentation is handy for the drive. However, since improper jumper settings may cause one or both drives to temporarily malfunction, it is best to get the settings correct. By having separate Interface Circuitry for each drive, jumper settings will not cause a drive to malfunction. In addition, our device may detect the current drive settings and communicate with them properly.

One advantage that our invention has over simply trying to compare drives using a computer is that our device is operating system independent. It does not care what kind of data is on the drive, it simply compares the drives. This allows it to complete the comparison regardless of the type of system that the drive was previously in.

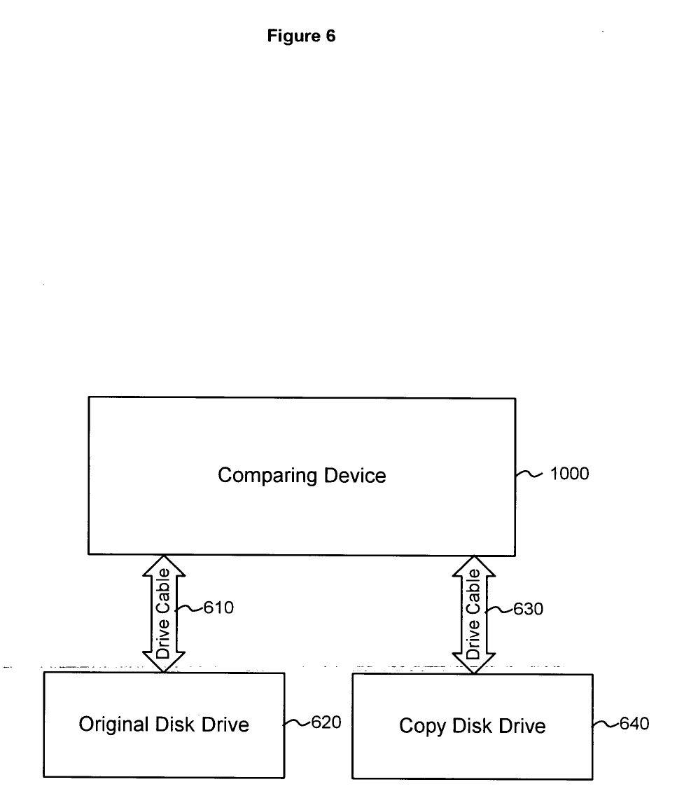

Please refer to FIG. 6. Our invention 1000 is a physical device that connects to two long-term storage devices such as hard drives (FIG. 1.) Our device is connected to an Original storage device through a standard cable 610 and to a Copy storage device through a standard cable 630. To each drive, our device appears to be a host computer.

In order to meet the goal of comparing all of the data on an Original and Copy drive, all of the data that resides on the Original must be compared. This would not seem to be a problem, but drives have functions that allow for data to be hidden. In order to fully compare two drives, the hidden data must be made available to our device. There are two primary methods for hiding data on an IDE hard drive. One is by setting a Host Protected Area (HPA) and the other is by using the Device Configuration Overlay (DCO) function.

Both of these methods hide data by causing the drive to report its size as smaller than it truly is. For instance, a 40 gigabyte drive could be instructed to report its size as 30 gigabytes. From that point on, any computer would see it as a 30 gigabyte drive. Any data stored in the area between 30 gigabytes and 40 gigabytes would be effectively hidden from the system

If the data is hidden using the HPA method, the drive may be instructed to make the hidden area accessible temporarily. When a temporary change command is issued, the drive resorts to its previous state the next time that the drive is powered off and on again. If, however, the DCO method is used, there is no such temporary change command. Making a change to DCO settings is permanent until changed again.

This has the potential to cause a problem, especially when working with sensitive information, such as a police evidence drive. Any permanent change to the drive has the potential to make the drive unreadable. Under normal circumstances, our device would make the change, compare the data, and restore the DCO to its original configuration. This is fine in theory, but doesn't take into account events such an unforeseen power failure. Should the power fail at a point in time when the DCO has been set away from its original settings, potentially the drive could be left in an unreadable state.

It is still vitally important to be able to compare an Original drive, even with the risk of a change to the drive. Our preferred embodiment uses the method as described in the U.S. patent application entitled “Systems and Methods for Restoring Critical Data to Computer Long-Term Memory Device Controllers” (patent application Ser. No. 10/765,345) to provide a method for restoring a drive to its original configuration. This keeps the risk down to an acceptable level.

### A MORE DETAILED LOOK AT A PREFERRED EMBODIMENT

Source drive interface 1030 allows connection to a drive through Interface Connector 1040. Similarly, Copy drive interface 1050 allows connection to a drive through Interface Connector 1060. Industry standard cables connect our device to the Source drive and the Copy drive. Our device, including cables, is physically designed to encourage an untrained user to connect it properly. When Drive Cable 610 is connected to Source Drive 620 and Drive Cable 630 is connected to Copy Drive 640, our device is ready to operate.

### A DETAILED LOOK AT LOGIC FLOW IN A PREFERRED EMBODIMENT

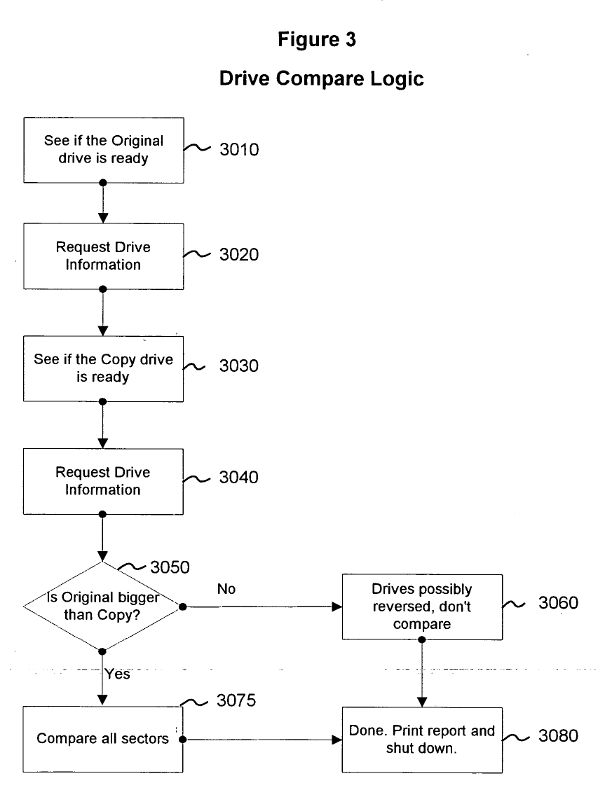

Please refer to FIG. 3, which details the logic flow in a preferred embodiment. On power up, our device detects the presence of an Original Drive and waits for it to become ready for operations 3010. Once the Original drive is determined to be ready, our device requests information about the drive 3020, such as its size and capabilities.

In a similar manner, our device detects the presence of a Copy drive and waits for it to become ready for operations 3030. Once the Copy drive is determined to be ready, our device requests information about the drive 3040, such as its size and capabilities.

A comparison is made 3050 to determine if the Copy drive is big enough to hold all of the contents of the Original drive. If the Copy drive is too small 3060, there is the possibility that the Original and Copy drives have been reversed. In this case the compare procedure is aborted and the user notified 3080, through methods such as LED status indicators, or a printout.

If the Copy drive is the same size as the Original or larger, then the data comparison procedure 3075 may begin. This comparison checks every byte in every sector of the Original drive to the Copy drive.

When complete, the user is notified through status indicators and possibly a printout 3080.

### A DETAILED LOOK AT AN ELECTRONIC BLOCK DIAGRAM OF A PREFERRED EMBODIMENT

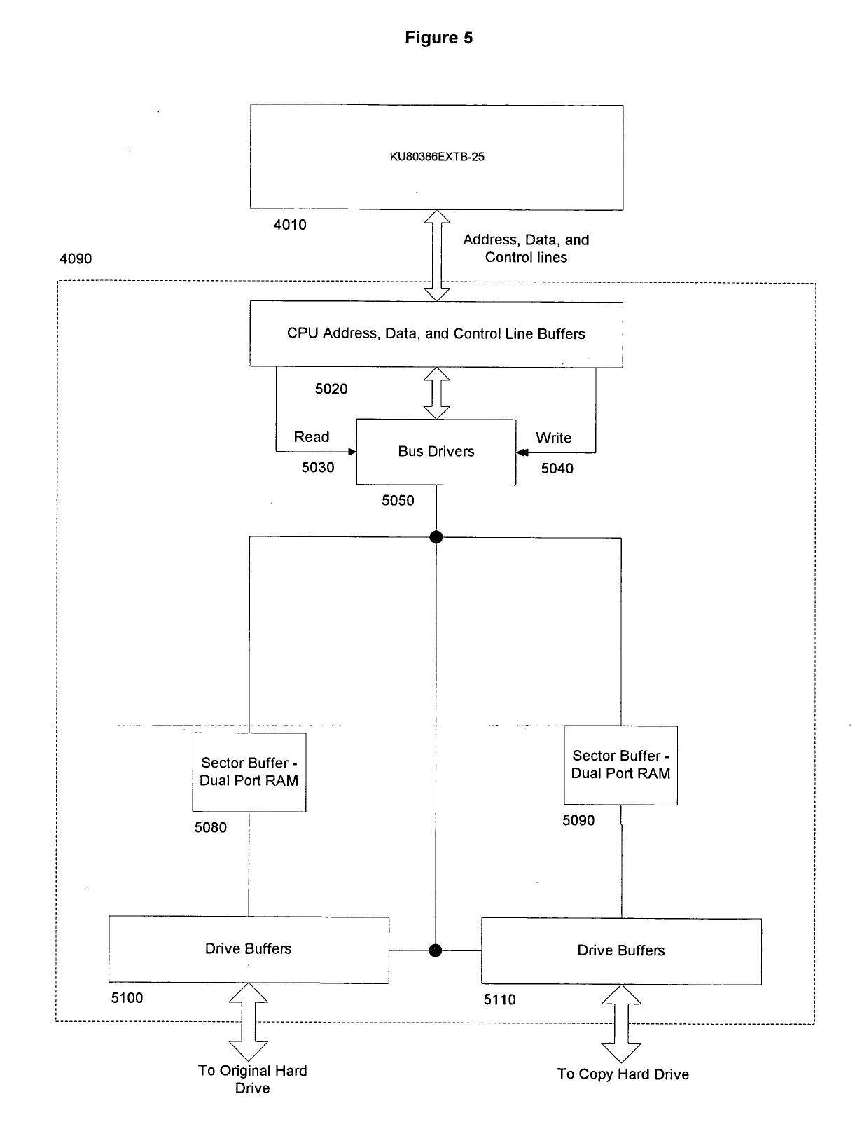

FIG. 5 is an illustration of a block diagram of our device. Our device uses an Intel 80386 EX embedded processor 4010 for its main control and logic function. This version of Intel's 80386 processor is optimized for embedded applications. The highly integrated design of this processor means that very little additional circuitry is necessary to create a small, dedicated computer system. Some static RAM is provided in 5040, which is used for temporary program and data storage. 5050 is an EPROM that holds the code necessary to initialize and run the processor. Timing is generated by a 50 MHz crystal oscillator, 5070.

The 80386EX 4010 has I/O pins available that may be used to connect additional devices. Three of these pins are used to power LED status indicators 5020 in order to provide feedback to a user. Another of these I/O pins, used as an input, may be used to connect a key lock 5030 to the processor.

A Programmable Logic Device, or PLD, is used to integrate numerous logical devices into a single chip 5090. Configuration data for the PLD is stored in a configuration ROM 5080. Timing for the PLD is generated by a 50 MHz crystal oscillator, 5070. When the PLD is reset, it automatically tries to load configuration information from its ROM. When configuration is complete, this single chip 5090 can be viewed as having all of the functionality shown in FIG. 6.

FIG. 5 shows a breakdown of the functions implemented by the PLD 4090. The address, data, and control lines from the processor 4010 are routed to the PLD. They are then buffered and latched in 4020 as necessary to reduce the electrical load on the processor and to stabilize the signal timing. Buffered read 4030 and write 4040 signals control the direction of the bus drivers shown in 4050. These buffers help control the data flow and distribution of the address and data busses from the processor to other functions in the PLD.

Buffering and signal conditioning for the Original Drive is provided by the Drive Buffers in 5100, making this the Drive Interface. Through the Bus drivers 5050 the processor can directly read and write to the Drive Interface. Another way that the processor and the Drive may communicate is through the Dual Ported RAM Sector Buffer 5080. This allows the drive to write one sector's worth of data to RAM at high speed, while the processor performs other tasks. By allowing the operations to overlap in this fashion, the processor is not restricted to running at the speed of the drive, and is free to handle other functions until it needs the data in the Sector Buffer.

Similarly, buffering and signal conditioning for the Copy Drive is provided by the Drive Buffers in 5110, making this the Drive Interface. Through the Bus drivers 5050 the processor can directly read and write to the Drive Interface. Another way that the processor and the Drive may communicate is through the Dual Ported RAM Sector Buffer 5090. This allows the drive to write one sector's worth of data from RAM at high speed, while the processor performs other tasks. By allowing the operations to overlap in this fashion, the processor is not restricted to running at the speed of the drive, and is free to handle other functions until it needs the data in the Sector Buffer.

The 80386EX processor 4010 has a UART built in that may be used for serial communications. For versions of our device that require such communication capabilities, the UART is connected to an RS-232 transceiver 4060. This part not only buffers the signals, it also generates the necessary voltages required for RS-232 communications. A standard DB9 connector 4120 allows our device to be connected to a computer using a standard DB9 male to female serial cable.

In the preferred embodiment, the goal of making this device foolproof for use by an untrained person is accomplished in a number of ways. The first is that the device is controlled by a single switch, such as Key Lock 4030. This switch has only two choices, on and off. When switched on, the device starts operation and provides any required feedback to the user through one or more indicators, such as LEDs 4020. Under normal circumstances, the only indicator that the user need be concerned with is the “Operation Complete” indicator. Additional indicators may be available for such error conditions as “Copy Drive Too Small” or “Comparison in Progress.” These indicators may be as simple as LEDs.

For additional detailed status, a printer may be connected to the device through communication port 4120. Information sent to the printer may include Drive identification information to uniquely identify the drives being compared. Should any errors occur, such as a bad sector on the Original disk, the sector number may be printed.

### Improved Comparing Device With Multiple Ports

There are cases where it is advantageous to validate that multiple copies of an original long-term storage device contain the same data as the Original. While this can be done one at a time using our invention as described herein, it is not always an optimal solution. An additional embodiment of our device adds additional drive interface circuitry to allow the connection of additional drives.

There is a dramatic time savings in being able to compare multiple drives at one time. For modern, large drives, it can take more than an hour to do a comparison. Assuming that it only took one hour to perform a comparison of a single drive, having to do this same comparison on four drives individually would take four hours. Using a device based on this additional embodiment would take only one hour to compare all four drives. This has another advantage that may not be so obvious. The less time that the Original drive is powered up, the lower the risk of a drive failure.

### Improved Comparing Device With External Port

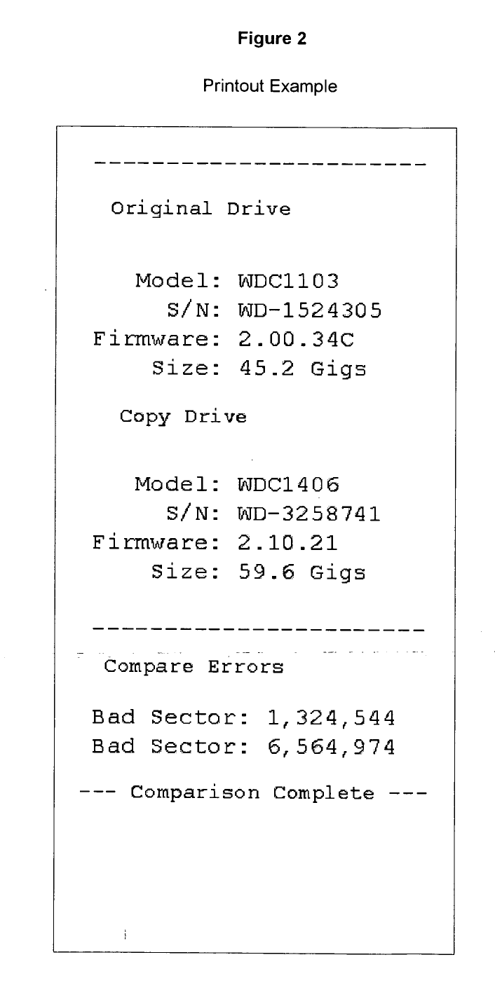

The preferred embodiment does not require an external port. Adding a port such as DB9 RS232 Port 4120 adds functionality to our improved comparing device at the cost of simplicity. This port may be used to drive a printer and print a report of the compare process. Please see FIG. 2 for an example of a print out. In addition, this port may be used to connect to a PC. Thus a report could be sent directly to a PC.

In another embodiment an external port may be used to connect to an external host. This may be used to enable a user to change compare functionality.

### Improved Comparing Device With Different Storage Interfaces

In another embodiment, the drives to be compared may have different interfaces. For example, the original storage device may interface to our invention through an IDE port while the copy storage device interfaces through a USB port.

### Improved Comparing Device With “Check Values”

In another embodiment, the comparing device calculates one or more “check values” for each storage device while comparing storage devices. Such a check value might be as simple as a checksum of the data on the drive, or as complex as an MD5 hash. MD5 hash values, for instance, are sometimes used as an additional check to insure that the data has not changed on a drive. When some copying devices make a copy of a drive, they create an MD5 value of the original drive. While a comparing device is capable of determining whether the storage devices attached to it are the same, an MD5 value can help verify that the data matches the original in the case where only copies are available.

While it is typical for a check value to be for made for all of the data on the drive, there are cases where it is advantageous to create check values for portions of the drive. The reason for this is in the case of a partial drive failure. If a check value for the entire drive does not match its reference value, there is not way to tell where the discrepancy may be. If check values were generated for each sector (512 bytes), the site of a single error would be able to be localized and the rest of the data on the drive treated as valid.

In this embodiment, the check values would be transmitted to a PC through the communications port and/or printed to a printer. Optionally, the communications port would allow the user to set the desired granularity or type of check values to be generated.

In another embodiment, the compare device would be able to generate check values on a single drive connected to it. In this case, the check value of a drive would be stored, and the drive could be re-checked at a later date to ensure the check values have not changed, and therefore, the information on the drive has not changed.

In another embodiment, check values and comparison status information may be stored in non-volatile memory within the device, such as flash memory, so that the information may be retrieved at a later time. Additional non- volatile memory may be provided by other types of long-term storage devices, such as compact flash cards, for later retrieval.

### Summary

As described above, an improved comparing device is physically connected to two or more computer long-term memory storage devices. The improved comparing device issues commands to compare data between these devices. An embedded processor within the improved comparing device controls functionality of the comparing device. The functionality of the embedded processor can be programmatically modified to allow for a number of different possible options.

It will be apparent to one of ordinary skill in the art that the embodiments as described above may be implemented in many different forms of software, firmware, and hardware in the implementations illustrated in the figures. The actual software code or specialized control hardware used to implement aspects consistent with the present invention is not limiting of the present invention. Thus, the operation and behavior of the embodiments were described without specific reference to the specific software code, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

The foregoing description of preferred embodiments of the present invention uses the term “processor”, but this term is not intended to limit the invention to a precise form. One skilled in the art will appreciate that a processor may also be described as; circuitry and logic algorithms.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. An improved comparing device comprising:
an interface and interface circuitry for connecting to a storage device (Original); and
an interface and interface circuitry for connecting to a storage device (Copy); and
a processor coupled to the interfaces, the processor issuing commands to perform a compare between the storage devices, wherein the improved comparing device is operating system and platform independent.

2. The improved comparing device of claim 1, wherein the interfaces are integrated device electronics (IDE) interfaces for a disk drive.

3. The improved comparing device of claim 1, further comprising:
additional interfaces and interface circuitry for connecting to additional storage devices.

4. The improved comparing device of claim 1, further including light emitting diodes (LEDs) coupled to the processor and configured to transmit status information relating to the comparing operations.

5. The improved comparing device of claim 1, further including an external interface port.

6. The improved comparing device of claim 1, wherein the processor issues commands to do a byte by byte comparison of the storage devices.

7. The improved comparing device of claim 1, further comprising:
memory to store data from the storage devices, wherein the processor is coupled to the memory.

8. The improved comparing device of claim 7, wherein the processor issues queries to the storage device's controllers, the processor storing all or part of the response in the memory.

9. The improved comparing device of claim 7, wherein after querying the storage device's controllers the processor issues commands to enable hidden data from the storage devices to be read.

10. The improved comparing device of claim 7, wherein after the compare process is complete, the processor issues commands to restore the storage device's controllers to their original states.

11. An improved comparing device comprising:
means for interfacing with storage devices, means for comparing data on the storage devices,

12. The improved comparing device of claim 11, further comprising:
means for accessing “hidden” areas on the storage devices,

13. The improved comparing device of claim 11, further comprising:
means for restoring the storage device's controllers to their original state,

14. The improved comparing device of claim 11, further comprising:
means to indicate status of comparing operation to a user.

15. The improved comparing device of claim 11, further comprising:
means for generating one or more “check sum” values.

16. The improved comparing device of claim 1, wherein the two interfaces are different types.

17. The improved comparing device of claim 1, wherein one interface is an integrated device electronics (IDE) and the other is a Universal Serial Bus (USB).

18. The improved comparing device of claim 1, wherein the processor issues commands to calculate one or more “check sum” values.

19. The improved comparing device of claim 18, wherein one of the “check sum” values is an MD5 hash.

20. The improved comparing device of claim 18, wherein the processor issues commands to calculate one or more “check sum” values for portions of a device.

21. The improved comparing device of claim 18, wherein the processor issues commands to calculate one or more “check sum” values for every sector of a device.
